(19) United States
(12) Patent Application Publication
(10) Pub. No.: US 2017/0089832 A1
(43) Pub. Date: Mar. 30, 2017

(54) GAS DETECTION METHOD AND GAS DETECTION DEVICE

(71) Applicant: KONICA MINOLTA, INC., Tokyo (JP)

(72) Inventors: Hideo UEMURA, Tokyo (JP); Kazuki IKEDA, Tokyo (JP); Takashi KUROSAWA, Tokyo (JP)

(73) Assignee: KONICA MINOLTA, INC., Tokyo (JP)

(21) Appl. No.: 15/242,400

(22) Filed: Aug. 19, 2016

(30) Foreign Application Priority Data
Sep. 25, 2015 (JP) 2015-187651

(51) Int. Cl. G01N 21/552; G01N 21/27; G01N 21/41

(52) U.S. Cl. CPC G01N 21/554; G01N 21/4133; G01N 21/272; G01N 2021/258

(57) ABSTRACT

Provided is a gas detection method using a localized surface plasmon sensor that can transmit, reflect, or scatter applied electromagnetic waves and that causes a change in a response spectrum of the applied electromagnetic waves due to interaction with a target to be detected, wherein the localized surface plasmon sensor includes at least an aggregate of particles having a core-shell structure composed of a core made of a substance having a maximum optical absorption peak wavelength due to surface plasmon resonances in an infrared region and a shell covering the core, the shell absorbs or reacts with the target to be detected to show a change in its refractive index, and the core has an average particle diameter D₁ of 0.6 μm or more but less than the maximum optical absorption peak wavelength of the core.

The entire disclosure of Japanese Patent Application No. 2015-187651 filed on Sep. 25, 2015 including description, claims, drawings, and abstract are incorporated herein by reference in its entirety.

### BACKGROUND OF THE INVENTION

Field of the Invention

The present invention relates to a gas detection method and a gas detection device. More specifically, the present invention relates to a gas detection method using a localized surface plasmon sensor and a gas detection device.

Description of the Related Art

As a sensor capable of detecting a chemical substance, a chemical reaction, or biological or genetic information, a sensor using an optical system based on surface plasmon resonance excited by light (hereinafter, referred to as surface plasmon resonance sensor) has been developed in recent years.

This surface plasmon resonance sensor utilizes a plasmon resonance phenomenon caused by the interaction between conduction electrons in a metal and light. More specifically, a change in the conditions, such as refractive index, of a micro region of several nanometers to several tens of nanometers in the vicinity of the surface of a metal structure caused by a chemical substance, a chemical reaction, or biological or genetic information is detected by the response of resonant wavelength of light due to a plasmon phenomenon. This technique is expected to be used for detecting a gas, especially an invisible gas that is difficult to detect.

For example, JP 10-2894 A discloses a method in which a detection agent is used which is obtained by allowing a carrier whose optical transmittance measured by a spectrophotometer is substantially 0 to support a discoloring substance whose color is changed by contact with a gas to be detected, and a color change of the detection agent is detected by a color mark sensor. The method disclosed in JP 10-2894 A is a method in which a color change of the detection agent (color mark sensor), which chemically reacts with a target gas to give a color, is measured by a spectroscope.

The method disclosed in JP 10-2894 A utilizes a chemical color reaction, and therefore cannot at all exert a detection effect on a substance that does not chemically react. That is, it is difficult to detect a substance that is less likely to chemically react. As a solution for such a problem, a plasmon phenomenon is expected to be used.

In a method utilizing a plasmon phenomenon, a metal thin film of gold, silver, or the like is generally used in a surface plasmon resonance sensor chip. In this case, light from the ultraviolet to the visible region is used for the surface plasmon resonance sensor.

Recently, plasmon research focused on oxide semiconductors instead of metals has been made. Oxide semiconductors have a wide band gap, and therefore the number of carriers can be arbitrarily controlled by the concentration of a dopant to be introduced, which makes it possible to use light from the visible to the near-infrared region. Therefore, an oxide semiconductor can be used as a surface plasmon resonance sensor using infrared light that is conventionally difficult to use, and is particularly expected to be applied to a non-invasive blood sugar level sensor in the field of biotechnology.

A specific example of a method using such a sensor based on a plasmon phenomenon is disclosed in JP 2007-255947 A. The method disclosed in JP 2007-255947 A is a method in which metal fine particles having such a size that a localized surface plasmon is excited are fixed to a light-permeable insulating thin film provided on a metal layer, and a change in second harmonic generated by interaction between the metal fine particles and incident light is detected to detect a refractive index change in the vicinity of the metal fine particles.

In such a case where plasmons using metal fine particles are utilized, an absorption wavelength peak shift due to plasmons in the visible region is generally detected, and therefore such a very small peak shift is detected using a device such as a spectrometer. The amount of the peak shift depends on the effective refractive index in the vicinity of the metal fine particles. Therefore, a gas component around the fine particles can be quantified by previously determining the correlation between a gas concentration and a peak shift amount.

Such a localized surface plasmon resonance sensor is a technique expected to be used in the future to quantify or detect a gas or liquid component that is conventionally difficult to measure.

The localized surface plasmon resonance sensor disclosed in JP 2007-255947 A detects a change in resonant wavelength peak associated with a change in optical constant around a metal structure with the use of a device such as a spectrometer to achieve its function as a sensor. However, a change in resonant wavelength peak caused by plasmon resonances is generally as very small as about several nanometers to several tens of nanometers. In order to detect such a very small wavelength change, a device having an expensive and complicated system, such as a spectrometer, is absolutely necessary. For this reason, such a localized surface plasmon resonance sensor is currently mainly used for fixed-point measurement in research institutes or production sites.

On the other hand, a typical field that will require such a surface plasmon resonance sensor in future is, for example, the field of colorless and odorless flammable gas plants. More specifically, hydrogen gas regarded as future CO₂-free energy is difficult to detect by a conventional sensor. Therefore, a plasmon sensor is expected to be used for the purpose of checking the leakage of hydrogen gas. At the site of production, transport, and storage of a large amount of hydrogen gas or the like, patrol for inspection is performed mainly by humans. Therefore, in order to use a plasmon sensor for the purpose of checking the leakage of hydrogen gas, there has been a demand for a method capable of readily visually recognizing a gas leak source by a patroller.

The plasmon sensor is excellent as a means for detecting a target, such as hydrogen gas, that is difficult to detect by a conventional technique, but it is difficult to reliably determine the detection of leakage of hydrogen gas or the like by the human eye.

In light of the above problem, there has been a strong demand for development of a method capable of reliably detecting the resonance wavelength peak shift of a plasmon sensor by the human eye.

### SUMMARY OF THE INVENTION

In view of the above problems and circumstances, it is an object of the present invention to provide a gas detection method using a localized surface plasmon sensor capable of determining the detection of a target, such as a gas, based on a color change when the target is detected by localized surface plasmon particles, and a gas detection device comprising a localized surface plasmon sensor.

In order to achieve the above object, the present inventor has intensively studied a means for detecting a gas such as hydrogen gas, and as a result has found that the detection of a target, such as a gas, can be determined not by detecting an absorption wavelength peak shift but by detecting a color change (ΔE) when the target is detected by localized surface plasmon particles by a gas detection method using a localized surface plasmon sensor that causes a change in a response spectrum of applied electromagnetic waves (e.g., a change in the intensity of color) due to interaction with a target to be detected (e.g., hydrogen gas), wherein the localized surface plasmon sensor comprises at least an aggregate of particles having a core-shell structure composed of a core made of a substance having a maximum optical absorption peak wavelength due to surface plasmon resonances in an infrared region and a shell covering the core, the shell has a property of absorbing or reacting with the target to be detected to show a change in its refractive index, and the core has an average particle diameter D₁ within a specific range. This finding has led to the completion of the present invention.

More specifically, the above object is achieved by the following means.

1. To achieve the abovementioned object, according to an aspect, a gas detection method reflecting one aspect of the present invention uses a localized surface plasmon sensor that can transmit, reflect, or scatter applied electromagnetic waves and that causes a change in a response spectrum of the applied electromagnetic waves due to interaction with a target to be detected, wherein

the localized surface plasmon sensor comprises at least an aggregate of particles having a core-shell structure composed of a core made of a substance having a maximum optical absorption peak wavelength due to surface plasmon resonances in an infrared region and a shell covering the core,

the shell absorbs or reacts with the target to be detected to show a change in its refractive index, and

the core has an average particle diameter D₁ of 0.6 μm or more but less than the maximum optical absorption peak wavelength of the core.

2. The gas detection method according to Item. 1, wherein the substance constituting the core is preferably an oxide semiconductor.

3. The gas detection method according to Item. 1, wherein the substance constituting the core is preferably zinc oxide.

4. The gas detection method according to any one of Items. 1 to 3, wherein the average particle diameter D₁ (μm) of the cores is preferably in a range of 0.60 to 1.30 μm.

5. The gas detection method according to Item. 4, wherein the average particle diameter D₁ (μm) of the cores is preferably in a range of 0.75 to 1.20 μm.

6. The gas detection method according to any one of Items. 1 to 5, wherein when an average particle diameter of the particles having a core-shell structure is defined as D₂ (μm), a requirement specified by the following formula (1) is preferably satisfied:

1.5×D₁ (μm)<D₂ (μm) Formula (1)

7. The gas detection method according to any one of Items. 1 to 6, wherein gas detection is preferably performed by

emitting visible light from a light source toward the localized surface plasmon sensor,

detecting spectral information of transmitted, reflected, or scattered light from the localized surface plasmon sensor by a detecting unit, and

calculating a color difference ΔE by a signal processor from the spectral information obtained by the detecting unit.

8. The gas detection method according to any one of Items. 1 to 7, wherein the localized surface plasmon sensor preferably has a color reference member, which causes no change in absorption wavelength due to gas adsorption, in a region other than a region where the particles having a core-shell structure, which cause a change in response spectrum due to gas adsorption, are present.

9. The gas detection method according to any one of Items. 1 to 8, wherein the shell is preferably composed of an enzyme comprising a biocatalyst.

10. The gas detection method according to any one of Items. 1 to 8, wherein the shell is preferably composed of a gasochromic metal.

11. To achieve the abovementioned object, according to an aspect, a gas detection device reflecting one aspect of the present invention comprises a localized surface plasmon sensor that can transmit, reflect, or scatter applied electromagnetic waves and that causes a change in a response spectrum of the applied electromagnetic waves due to interaction with a target to be detected, wherein

the localized surface plasmon sensor comprises at least an aggregate of particles having a core-shell structure composed of a core made of a substance having a maximum optical absorption peak wavelength due to surface plasmon resonances in an infrared region and a shell covering the core,

the shell absorbs or reacts with the target to be detected to show a change in its refractive index, and

the core has an average particle diameter D₁ of 0.6 μm or more but less than the maximum optical absorption peak wavelength of the core.

12. The gas detection device according to Item. 11, wherein the substance constituting the core is preferably an oxide semiconductor.

13. The gas detection device according to Item. 11, wherein the substance constituting the core is preferably zinc oxide.

14. The gas detection device according to any one of Items. 11 to 13, wherein the average particle diameter D₁ (μm) of the cores is preferably in a range of 0.60 to 1.30 μm.

15. The gas detection device according to Item. 14, wherein the average particle diameter D₁ (μm) of the cores is preferably in a range of 0.75 to 1.20 μm.

16. The gas detection device according to any one of Items. 11 to 15, wherein when an average particle diameter of the particles having a core-shell structure is defined as D₂ (μm), a requirement specified by the following formula (1) is preferably satisfied:

1.5×D₁ (μm)<D₂ (μm) Formula (1)

17. The gas detection device according to any one of Items. 11 to 16, preferably comprising:

a light source unit that emits visible light toward the localized surface plasmon sensor;

a detecting unit that detects spectral information of transmitted, reflected, or scattered light from the localized surface plasmon sensor; and

a signal processor that calculates a color difference ΔE from the spectral information obtained by the detecting unit.

18. The gas detection device according to any one of Items. 11 to 17, wherein the localized surface plasmon sensor preferably has a color reference member, which causes no change in absorption wavelength due to gas adsorption, in a region other than a region where the particles having a core-shell structure, which cause a change in response spectrum due to gas adsorption, are present.

19. The gas detection device according to any one of Items. 11 to 18, wherein the shell is preferably composed of an enzyme comprising a biocatalyst.

20. The gas detection device according to any one of Items. 11 to 18, wherein the shell is preferably composed of a gasochromic metal.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a schematic view showing one example of a gas detection method using a localized surface plasmon sensor;

FIG. 2 is a schematic sectional view showing one example of the structure of a localized surface plasmon sensor in which core-shell-type particles are arranged on a substrate;

FIG. 3 is a graph showing one example of a relationship between the average particle diameter D₁ of cores and a color difference ΔE; and

FIG. 4 is a flow chart showing one example of a method for calculating a color difference ΔE from spectral intensity.

### DESCRIPTION OF THE PREFERRED EMBODIMENTS

Hereinafter, an embodiment of the present invention will be described with reference to the drawings. However, the scope of the invention is not limited to the illustrated examples. It is to be noted that “to” used between numerical values in this application means a range including the numerical values described before and after “to” as a lower limit and an upper limit.

A gas detection method according to an embodiment of the present invention is a gas detection method using a localized surface plasmon sensor that can transmit, reflect, or scatter applied electromagnetic waves and that causes a change in a response spectrum of the applied electromagnetic waves due to interaction with a target to be detected, wherein the localized surface plasmon sensor comprises at least an aggregate of particles having a core-shell structure composed of a core made of a substance having a maximum optical absorption peak wavelength due to surface plasmon resonances in an infrared region and a shell covering the core, the shell absorbs or reacts with the target to be detected to show a change in its refractive index, and the core has an average particle diameter D₁ of 0.6 μm or more but less than the maximum light absorption peak wavelength of the core. This is a technical feature common to the inventions according to Items. 1 to 20.

According to a preferred embodiment of the present invention, from the viewpoint of more effectively achieving the desired effect of the present invention, the substance constituting the core is an oxide semiconductor. This makes it possible to control a plasmon resonant wavelength in the infrared region and therefore to achieve an optimum design for detecting a color change.

According to a preferred embodiment of the present invention, the oxide semiconductor constituting the core is zinc oxide. This is because zinc oxide is excellent in performance as a sensor and occurs in nature in abundance, and therefore there is no risk of depletion of supply. In addition, crystals of zinc oxide can be grown in a low-temperature environment, which contributes also to a reduction in cost.

According to a preferred embodiment of the present invention, the average particle diameter D₁ (μm) of the cores constituting the particles having a core-shell structure is in the range of 0.60 to 1.30 μm. This makes it possible to achieve a color difference ΔE of 4.0 or more as the width of a color change caused by a change in the refractive index of the shell and therefore to increase the accuracy of gas detection.

When the average particle diameter D₁ (μm) of the cores is in the range of 0.75 to 1.20 μm, a color difference ΔE of 10 or more can be achieved. This makes it possible to prevent false detection and therefore to perform gas detection with a high degree of accuracy.

According to a preferred embodiment of the present invention, when an average particle diameter of the particles having a core-shell structure is defined as D₂ (μm), a requirement specified by the above formula (1) is satisfied. This makes it possible to prevent variations in performance as a sensor resulting from variations in the thickness of the shell at the time of production.

According to a preferred embodiment of the present invention, the gas detection method comprises emitting visible light from a light source toward the localized surface plasmon sensor, detecting spectral information of transmitted, reflected, or scattered light from the localized surface plasmon sensor by a detecting means, and calculating a color difference ΔE by a signal processor from the spectral information obtained by the detecting means. This makes it possible to perform gas detection with a high degree of detection accuracy without the influence of noise in a measurement environment or of differences among individuals who monitor the sensor.

According to a preferred embodiment of the present invention, the localized surface plasmon sensor has a color reference member, which causes no change in absorption wavelength due to gas adsorption, in a region other than a region where the particles having a core-shell structure that cause a change in response spectrum due to gas adsorption are present. This makes it possible to reliably determine a relative color change of the localized surface plasmon sensor. Therefore, it is not necessary to perceive both colors before and after the change caused by gas adsorption, which makes it easy to determine gas detection.

According to a preferred embodiment of the present invention, the shell is composed of an enzyme comprising a biocatalyst. This makes it possible to allow the shell to have selective reactivity with an organic substance and therefore to improve sensitivity when gas molecules as noise are present other than the target to be detected.

According to a preferred embodiment of the present invention, the shell is composed of a gasochromic metal. This makes it possible to allow the shell to have selective reactivity with an inorganic volatile such as hydrogen gas. In addition, brightness is changed by a transmittance change caused by a gasochromic reaction, which causes a color change greater than that caused only by a refractive index change.

A gas detection device according to an embodiment of the present invention is a gas detection device comprising a localized surface plasmon sensor that can transmit, reflect, or scatter applied electromagnetic waves and that causes a change in a response spectrum of the applied electromagnetic waves due to interaction with a target to be detected, wherein the localized surface plasmon sensor comprises at least an aggregate of particles having a core-shell structure composed of a core made of a substance having a maximum optical absorption peak wavelength due to surface plasmon resonances in an infrared region and a shell covering the core, the shell absorbs or reacts with the target to be detected to show a change in its refractive index, and the core has an average particle diameter D₁ of 0.6 μm or more but less than the maximum light absorption peak wavelength of the core.

Hereinbelow, the gas detection method and the gas detection device according to the present invention will be described in detail.

(Plasmon Resonance)

In the present invention, a plasmon refers to a compressional wave (=longitudinal wave) of electrons in a metal nanoparticle excited by light. A plasmon is not generated by light in all wavelength regions. A plasmon resonance occurs when the frequency of light coincides with the natural frequency of surface electrons in a metal or the like.

When a plasmon resonance occurs, the energy of light at the frequency of the plasmon resonance is consumed by excitation of electron oscillation, and therefore light absorption occurs at the plasmon resonant frequency (wavelength). At this time, the plasmon resonant frequency is determined by a difference in refractive index (in a broad sense, permittivity) as a boundary condition at the interface between a substance having surface electrons, such as a metal, and another substance. The resonant frequency is changed also by changing the refractive index of the another substance.

A plasmon resonance phenomenon is broadly divided into two types: one is a propagating surface plasmon that is oscillation of free electrons in a metal surface coupled with light and propagating on the metal surface; and the other is a localized surface plasmon generated by oscillation of electrons polarized by the electric field of incident light in the entire nanoparticle of a metal or the like.

A propagating surface plasmon is considered to be applied to wavelength filters or biosensors, because the properties thereof can be controlled by providing a microstructure on the surface of a metal of an element even when the size of the element is large. However, it is difficult to change the properties at the element level, which makes it difficult for the element to have multiple channels. Further, when the element is used as a sensor, a high sensitive detection device is required to detect plasmon excitation light, which is disadvantageous in that the system of the detection system is likely to be complicated and upsized.

On the other hand, a localized surface plasmon is suitable for multi-channel biosensors or quarantine systems, because a minimum unit of an element corresponds to one nanoparticle, and therefore the element can be easily downsized. The present invention utilizes such a localized surface plasmon.

It is generally said that the particle diameter of a nanoparticle appropriate to the occurrence of a localized surface plasmon resonance is in the range of 10 to 150 nm. This is attributed to the fact that a peak wavelength at which a plasmon resonance occurs (hereinafter, referred to as plasmon resonant frequency (wavelength)) is equal to or less than the size of the nanoparticle. Under such a condition, the plasmon resonant frequency is shifted by a change in refractive index around the nanoparticle, but a color (hue) perceived by the human eye hardly changes. In fact, when a plasmon resonant frequency shift caused by a refractive index change due to the adsorption of hydrogen gas is represented by a color difference ΔE as the amount of color change in consideration of the spectral luminous efficiency of the human eye, ΔE % 1.0 to 2.0.

Hereinbelow, the principle of the structure specified in the present invention will be described in detail.

The human eye can more readily perceive, as a color change, a brightness change than a color saturation change. This will be described below in terms of spectral intensity. For example, when the peak wavelength of a peak at a resonant wavelength in the visible region is shifted only by about several nanometers to several tens of nanometers, a change in the intensity of the peak is not large, and is therefore difficult to visually recognize as a color change by the human eye. On the other hand, when the intensity of light at a certain wavelength is changed, the human eye can readily perceive such a light intensity change as a color change. The same goes for the entire visible light region. Therefore, the human eye can readily perceive a color change by greatly changing the total area of (absorption) spectral intensity in the entire visible region.

Hereinbelow, the technical features of the gas detection method and the gas detection device according to the present invention will be described in detail with reference to some of the drawings.

### First Embodiment

The gas detection method or the gas detection device according to the present invention (in the following description, collectively called “gas detection method”) is a gas detection method using a localized surface plasmon sensor that can transmit, reflect, or scatter applied electromagnetic waves and that causes a change in a response spectrum of the applied electromagnetic waves due to interaction with a target to be detected, wherein the localized surface plasmon sensor comprises at least an aggregate of particles having a core-shell structure composed of a core made of a substance having a maximum optical absorption peak wavelength due to surface plasmon resonances in an infrared region and a shell covering the core, the shell absorbs or reacts with the target to be detected to show a change in its refractive index, and the core has an average particle diameter D₁ of 0.6 μm or more but less than the maximum light absorption peak wavelength of the core.

The structure specified in the first embodiment makes it possible to cause a great change in absorption wavelength due to a change in the refractive index of the shell in consideration of the spectral luminous efficiency of the human eye. When the core uses a substance having a plasmon resonant frequency in the infrared region and the average particle diameter D₁ of the cores is set to 0.6 μm or more but less than the maximum optical absorption peak wavelength of the core, the core as a particle can have a plasmon resonant frequency in the infrared region. Such a structure makes it possible to cause a great change in the area of spectral intensity in the visible region when an absorption wavelength peak shift in the infrared region occurs. As a result, the width of a color change is increased. At this time, the core generally has a spherical shape. However, the same effect can be achieved even when the core has a planar shape such as a multangular shape, a plate shape or a nanowire shape. The shell that shows a change in its refractive index may be configured to adsorb a gas either chemically or physically.

<Summary of Gas Detection Method>

Hereinbelow, the gas detection method according to the present invention will be summarized with reference to the drawings. However, the gas detection method according to the present invention is not limited to a method exemplified here.

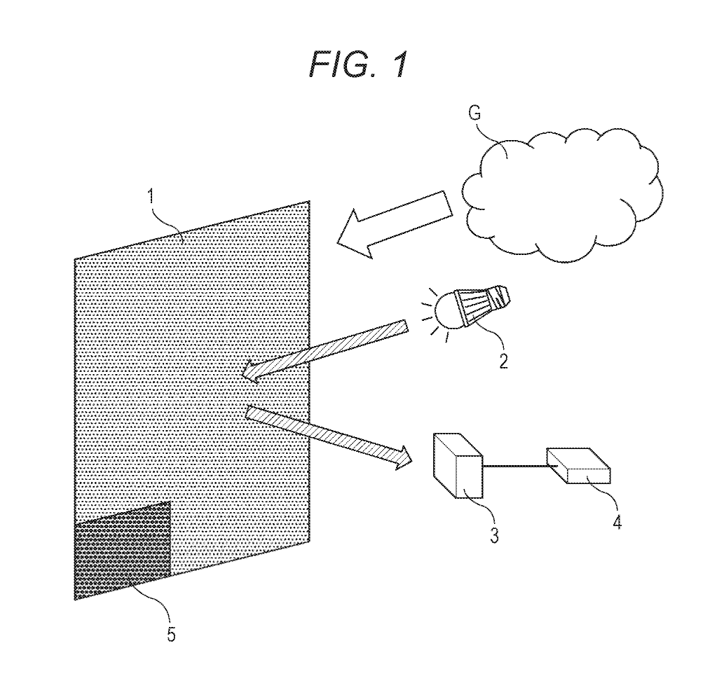

FIG. 1 is a schematic view showing one example of the gas detection method using a localized surface plasmon sensor according to the first embodiment.

A localized surface plasmon sensor (1) shown in FIG. 1 shows a color change caused by a gas (G). The localized surface plasmon sensor (1) contains particles having a core-shell structure to determine the presence or absence of the gas (G) as a target by detecting a hue change of the particles.

In order to ensure high accuracy, the gas detection method or the gas detection device shown in FIG. 1 comprises, in addition to the localized surface plasmon sensor (1) as a basic component, a light source (2) for irradiating the localized surface plasmon sensor (1) with electromagnetic waves, a detection device (3) that detects the spectral information of transmitted, reflected, or scattered light from the localized surface plasmon sensor, a signal processor (4) that calculates a color difference ΔE from the spectral information obtained by the detection device that will be described later, and a color reference member (5). The signal processor (4) calculates a color difference ΔE and determines whether the color difference ΔE is equal to or more or less than a threshold value to determine the presence or absence of a gas. At this time, the color difference ΔE between the localized surface plasmon sensor (1) and the color reference member (5) is calculated based on the color of the color reference member (5) as a reference color.

<Basic Structure of Localized Surface Plasmon Sensor>

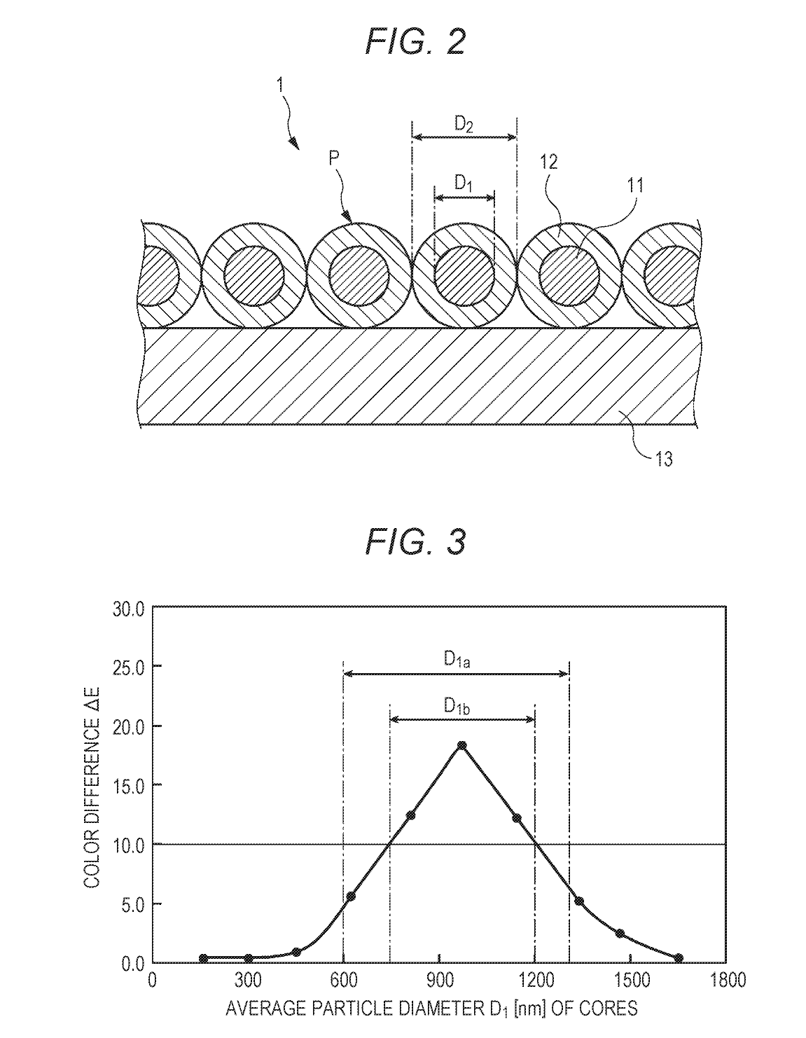

FIG. 2 is a schematic sectional view showing one example of the structure of a localized surface plasmon sensor applied to the gas detection method according to the present invention, in which core-shell-type particles are arranged on a substrate.

A localized surface plasmon sensor (1) shown in FIG. 2 has a structure in which a plurality of particles (P) are fixed to and arranged on a planar substrate (13). The particles (P) have an average particle diameter D₂ and are each composed of a core (11) having an average particle diameter D₁ and a shell (12) covering part or all of the surface of the core (11). Such a structure allows the localized surface plasmon sensor (1) to function as a sensor.

It is preferred that the planar substrate (13) is transparent to light from the visible to the infrared region and has a high refractive index. The refractive index of the substrate is preferably in the range of 1.30 to 4. The refractive index of the substrate is more preferably in the range of 1.40 to 3. For example, glass or resin is preferably used.

Examples of a usable resin substrate include conventionally-known various resin films such as cellulose ester-based films, polyester-based films, polycarbonate-based films, polyarylate-based films, polysulfone (including also polyethersulfone)-based films, polyester films such as polyethylene terephthalate films and polyethylene naphthalate films, polyethylene films, polypropylene films, cellophane, cellulose diacetate films, cellulose triacetate films, cellulose acetate propionate films, cellulose acetate butyrate films, polyvinylidene chloride films, polyvinyl alcohol films, ethylene vinyl alcohol films, syndiotactic polystyrene-based films, polycarbonate films, norbornene-based resin films, polymethylpentene films, polyether ketone films, polyether ketone imide films, polyamide films, fluorine resin films, nylon films, polymethylmethacrylate films, and acrylic films. Alternatively, the substrate (13) may be made of silicon. The substrate (13) may be configured so that light is emitted from the substrate (13) side like the tip of an optical fiber.

The core-shell-type particles according to the present invention may be prepared by a conventionally-known preparation method appropriately selected so that core-shell-type particles having the structure specified in the present invention can be obtained.

A method for preparing core-shell-type particles having a core made of zinc oxide as an oxide semiconductor will be described as one example.

1) First, an aqueous zinc solution, a urea-based aqueous solution, and an aqueous solution containing other additives for forming a core are prepared in the step of preparing raw material liquids.

2) In the step of forming zinc-based compound precursor particles (core particles), the above aqueous solutions are mixed with stirring at a certain temperature for a certain time to generate seed particles and grow the seed particles. In this way, zinc-based compound precursor particles are formed as core particles.

3) An aqueous solution containing materials for forming a shell is added to the aqueous solution containing the core particles to form a shell covering the surface of the core particles.

4) In the step of solid-liquid separation, the zinc-based compound precursor particles (core particles) prepared above are separated from the aqueous solution by solid-liquid separation.

5) Then, the separated zinc-based compound precursor particles (core particles) are subjected to calcination treatment at a predetermined temperature for a predetermined time to prepare spherical particles having a core-shell structure.

The structure of the particles having a core-shell structure according to the present invention prepared in the above manner will be described later in detail, but when the average particle diameter of the cores (11) is defined as D₁ and the average particle diameter of the particles having a core-shell structure is defined as D₂ (μm), a relationship represented by 1.5×D₁ (μm)<D₂ (μm) is preferably satisfied.

<Average Particle Diameter Measuring Method>

In the present invention, the average particle diameter of the cores constituting the particles (P) and the average particle diameter of the particles having a core-shell structure can be easily determined by applying a known particle diameter measuring method. For example, the average particle diameter can be determined using a commercially-available particle diameter measuring device based on a light scattering, electrophoresis, or laser Doppler method, such as a particle size analyzer (Multisizer III manufactured by Beckman Coulter, Inc.) and analysis software (Beckman Coulter Multisizer 3 Version 3.51). Alternatively, the average particle diameter may be determined by taking the images of at least 100 particles through a transmission electron microscope and statistically processing the images using image analysis software such as Image-Pro (manufactured by Media Cybernetics). Alternatively, the average particle diameter D₁ of the cores (11) may be determined in the following manner. The particles having a core-shell structure are subjected to cross-section processing by a focused ion beam system (FB-2000A) manufactured by Hitachi High-Technologies Corporation to expose surfaces passing through near the center of the particles. Then, the exposed cut surfaces are subjected to elemental analysis using STEM-EDX (HD-2000) manufactured by Hitachi High-Technologies Corporation to measure the composition distribution of the particles to determine regions different in composition as the core and the shell.

### Second Embodiment

According to a preferred embodiment (second embodiment) of the gas detection method of the present invention, an oxide semiconductor is used as the substance constituting the core and having a peak at a plasmon resonant frequency in the infrared region.

The plasmon resonant frequency ωₚ according to the present invention can be determined by the following formula (1).

ωₚ=(ne²/εm)^{1/2} Formula (1)

In the formula (1), n is electron density, e is the charge of an electron, ε is permittivity, and m is effective mass.

The electron mobility of an oxide semiconductor is in the range of about 1×10¹⁸ to 1×10²¹ cm⁻³, and therefore a plasmon resonant wavelength can be controlled in the near-infrared to the infrared region. It can be said that this is the feature of a semiconductor having electron mobility as an extra control parameter unlike a metal whose physical properties cannot be controlled. The use of an oxide semiconductor that makes it possible to control a plasmon resonant wavelength in the infrared region makes it possible to achieve an optimum design for color change.

Examples of the oxide semiconductor that can be used for forming the core include TiO₂, ITO (Indium Tin Oxide), ZnO, Nb₂O₅, ZrO₂, CeO₂, Ta₂O₅, Ti₃O₅, Ti₄O₇, Ti₂O₃, TiO, SnO₂, La₂Ti₂O₇, IZO (Indium Zinc Oxide), AZO (Aluminum Zinc Oxide), GZO (Gallium Zinc Oxide), ATO (Antimony Tin Oxide), ICO (Indium Cerium Oxide), Bi₂O₃, a-GIO, Ga₂O₃, GeO₂, SiO₂, Al₂O₃, HfO₂, SiO, MgO, Y₂O₃, WO₃, and a-GIO (Gallium Indium Oxide).

### Third Embodiment

According to a preferred embodiment (third embodiment) of the gas detection method of the present invention, a specific example of the oxide semiconductor specified in the second embodiment is zinc oxide (hereinafter, referred to as ZnO).

ZnO is a typical n-type semiconductor, has high optical properties, semiconductor properties, and piezoelectric properties, and is therefore conventionally used in the fields of pyroelectric elements, piezoelectric elements, gas sensors, and transparent conductive films as a material having excellent functions. In the present invention, the merits of using ZnO as the oxide semiconductor constituting the core are as follows. ZnO is not only excellent in performance as a sensor but also occurs in abundance. Therefore, from the viewpoint of production, ZnO is stably supplied for the time being without the risk of depletion of resources. In addition, crystals of ZnO can be grown at low temperature, which contributes also to a reduction in cost.

### Fourth Embodiment

According to a preferred embodiment (fourth embodiment) of the gas detection method of the present invention, the average particle diameter D₁ (μm) of the cores is in the range of 0.60 to 1.30 μm.

When the average particle diameter D₁ (μm) of the cores is in the range of 0.60 to 1.30 μm, it is possible to achieve a color difference ΔE of 4.0 or more as the width of a color change caused by a change in the refractive index of the shell. In general, it is said that when a color difference ΔE before and after a color change is 4.0 or more, the change can be recognized by the human eye. On the other hand, assuming that the refractive index change is caused by hydrogen gas, the amount of the refractive index change Δn of the shell is about 0.1. The Δn caused by gas adsorption is minimum when hydrogen gas is adsorbed. Therefore, even when another gas is adsorbed, a color change can be sufficiently visually recognized as long as a color difference ΔE of 4 or more is ensured when hydrogen gas is adsorbed.

### Fifth Embodiment

According to a more preferred embodiment (fifth embodiment) than the fourth embodiment of the gas detection method of the present invention, the average particle diameter D₁ (μm) of the cores is in the range of 0.75 to 1.20 μm.

The structure specified in the fifth embodiment makes it possible to achieve a color difference ΔE of 10 or more. When a color change caused by gas adsorption has such characteristics that a color difference ΔE is 10 or more, it is possible to more accurately detect the color change with little false recognition.

FIG. 3 is a graph showing one example of the relationship between the average particle diameter D₁ of the cores and a color difference ΔE under the condition where the amount of refractive index change of the shell is 0.1.

The graph shown in FIG. 3 is obtained by plotting the average particle diameter D₁ (μm) of the cores along the horizontal axis and the measured value of a color difference ΔE achieved by the core-shell-type particles along the vertical axis.

As shown in FIG. 3, the color difference ΔE shows an upward-convex profile having a maximum value by changing the average particle diameter D₁ (μm) of the cores.

In general, a standard color difference ΔE at which a difference between colors can be recognized by humans is 4.0. Therefore, it is important to set the conditions of the localized surface plasmon sensor so that a color difference ΔE exceeds the threshold value. In the present invention, the average particle diameter D₁ (μm) of the cores is set to 0.6 μm or more but less than the maximum optical absorption peak wavelength of the core. More specifically, as specified in the fourth embodiment, a color difference ΔE can be set to 4.0 or more by setting the average particle diameter D₁ (μm) of the cores to a value in the range of 0.60 to 1.30 μm, that is, in the range of the average particle diameter D₁ₐ of the cores shown in FIG. 3. Further, as specified in the fifth embodiment, a color difference ΔE can be set to 10.0 or more by setting the average particle diameter D₁ (μm) of the cores to a value in the range of 0.75 to 1.20 μm, that is, in the range of the average particle diameter D_{1b} of the cores shown in FIG. 3, which makes it possible to detect a gas or the like with a higher degree of accuracy.

### Sixth Embodiment

According to a preferred embodiment (sixth embodiment) of the gas detection method according to the present invention, when an average particle diameter of the cores is defined as D₁ (μm) and an average particle diameter of the particles having a core-shell structure is defined as D₂ (m), a requirement specified by the following formula (1) is satisfied.

1.5×D₁ (μm)<D₂ (μm) Formula (1)

When the requirement specified in the sixth embodiment is satisfied, it is possible to reduce variations in performance as a sensor resulting from variations in the thickness of the shell at the time of production.

Hereinbelow, the principle on which variations in performance occur in the localized surface plasmon sensor will be described. The particles having a core-shell structure according to the present invention each have two interfaces, that is, an interface between the core and the shell and an interface between the shell and the outside of the shell. The plasmon resonance of each of the particles having a core-shell structure occurs in the vicinity of the interface between the core and the shell. If the thickness of the shell [(D₂−D₁)/2] is too small, the interface between the shell and the outside of the shell is included in a region where a plasmon occurs, and therefore the refractive index of the outside of the shell also affects the plasmon resonant frequency. Further, the plasmon resonant frequency depends on the effective (average) refractive index in a region where a plasmon occurs, and therefore the degree of entry of a region outside the shell into the region of a plasmon occurring at the interface between the core and the shell affects the characteristics of the particle. That is, when the thickness of the shell is smaller than the region where a plasmon occurs, the individual particles vary in their characteristics due to variations in the thickness of the shell at the time of production. On the other hand, when the thickness of the shell is larger than a range affected by a plasmon, the plasmon resonant frequency always depends on only the difference in refractive index between the core and the shell even when the thickness of the shell slightly varies at the time of production. Such a requirement is satisfied when a relationship represented by 1.5×D₁ (μm)<D₂ (μm) is satisfied, and therefore the thickness of the shell that does not affect the plasmon resonant frequency due to its variations depends on the diameter of the core.

### Seventh Embodiment

According to a preferred embodiment (seventh embodiment) of the gas detection method of the present invention, gas detection is performed by emitting visible light from a light source toward the localized surface plasmon sensor, detecting spectral information of transmitted, reflected, or scattered light from the localized surface plasmon sensor by a detecting means, and calculating a color difference ΔE by a signal processor from the spectral information obtained by the detecting means.

The structure specified in the seventh embodiment, more specifically, the above-described structure illustrated in FIG. 1 makes it possible to mechanically calculate a color difference ΔE in an environment where the amount of light is controlled to be constant. This makes it possible to prevent detection accuracy from being affected by noise in an observation environment or differences among individuals who monitor the sensor.

A specific method for calculating a color difference ΔE from spectral intensity by the signal processor according to the seventh embodiment will be described using a flow chart.

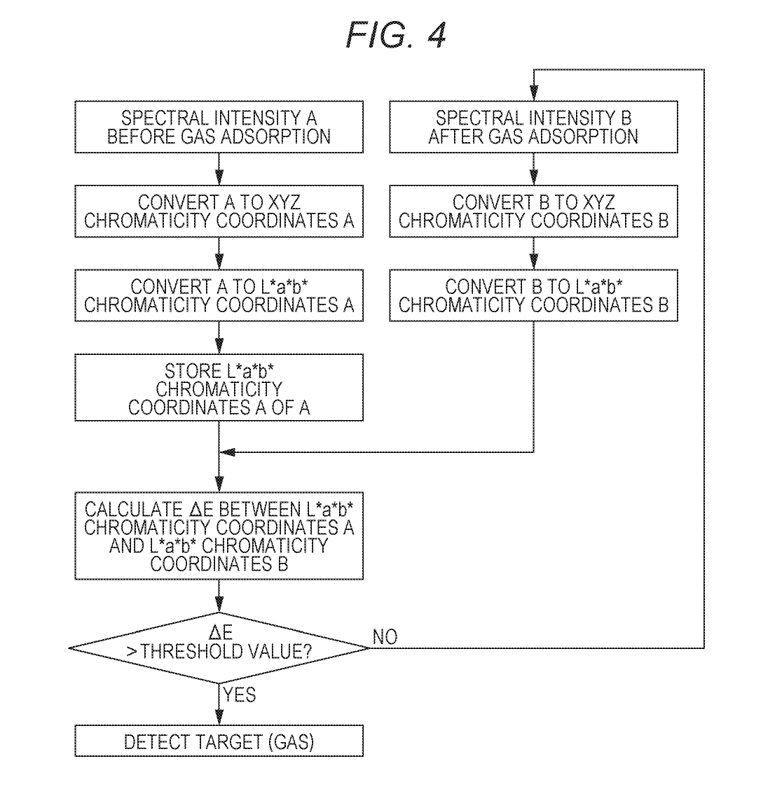

FIG. 4 is a flow chart showing one example of a method for calculating a color difference ΔE from spectral intensity.

First, a flow chart before reaction when a color change has not yet occurred will be described. In the localized surface plasmon sensor, the information of spectral intensity A before reaction when a color change due to a gas or the like has not yet occurred is converted to XYZ chromaticity coordinates A in the XYZ color system, and the XYZ chromaticity coordinates A are further converted to L*a*b* chromaticity coordinates A in the L*a*b color system. The L*a*b* chromaticity coordinates A in the initial state are stored in the signal processor as reference values.

Then, the spectral intensity B of the localized surface plasmon sensor that has reacted with a gas to show a color change is measured at a specific timing and converted to XYZ chromaticity coordinates B in the XYZ color system, and the XYZ chromaticity coordinates B are further converted to L*a*b* chromaticity coordinates B in the L*a*b* color system.

Then, a distance between the L*a*b* chromaticity coordinates A in the initial state measured above as reference values and the L*a*b* chromaticity coordinates B after color change is calculated as a color difference ΔE. At the timing when the calculated color difference ΔE exceeds a threshold value, it is judged that a target gas is detected.

When a target gas is detected, that is, when the color difference ΔE exceeds a threshold value (specified value), an alarm device or the like separately provided gives an alert, and the signal processor provides information to close a supply valve provided in a pipe connected to a gas tank or the like as the leak source of a gas such as hydrogen gas or to stop a gas supply unit.

The XYZ color system is one CIE color system that takes the sensitivity of the human eye to each color (spectral luminous efficiency) into consideration. However, when the xy chromaticity diagram of the XYZ color system is directly used, there is a problem that the amount of displacement on the coordinates caused by a color change varies from area (color) to area (color). Like this time, in order to evaluate a difference between colors based on a uniform index, that is, to linearize the perception of a color difference, the XYZ color system is further converted to the L*a*b* color system.

Specifically, the color difference ΔE between the spectral intensity A before reaction and the spectral intensity B after color change caused by reaction with a gas is determined according to the following method.

The L*a*b* chromaticity coordinates A of the spectral intensity A before reaction and the L*a*b* chromaticity coordinates B after reaction with a gas are measured using, for example, X-rite 938 Spectrodensitometer (manufactured by X-Rite) under D50 illuminant and 2° visual field at 10 points, respectively to determine the values of L*, a*, and b*. The color difference ΔE between the spectral intensity A and the spectral intensity B is determined using the following formula (2).

ΔE={(ΔL*)²+(Δa*)²+(Δb*)²}^{1/2} Formula (2)

Here, ΔL* is a difference between L* of the spectral intensity A and L* of the spectral intensity B, Δa* is a difference between a* of the spectral intensity A and a* of the spectral intensity B, and Δb* is a difference between b* of the spectral intensity A and b* of the spectral intensity B.

The color difference can be measured using a spectrophotometer CM-2002 (manufactured by Konica Minolta Sensing).

### Eighth Embodiment

According to a preferred embodiment (eighth embodiment) of the gas detection method of the present invention, the localized surface plasmon sensor has a color reference member, which causes no change in absorption wavelength due to gas adsorption, in a region other than a region where the particles having a core-shell structure, which cause a change in response spectrum due to gas adsorption, are present.

The structure illustrated in FIG. 1, in which the reference member that shows no color change due to gas adsorption or the like is provided, makes it possible to reliably determine a relative color change of the localized surface plasmon sensor. Therefore, it is not necessary to perceive both colors before and after the change caused by gas adsorption, which makes it easy to determine gas detection.

### Ninth Embodiment

According to a preferred embodiment (ninth embodiment) of the gas detection method according to the present invention, the shell is composed of an enzyme comprising a biocatalyst.

When the shell is formed to have the structure specified in the ninth embodiment, the shell can have selective reactivity with an organic substance, and measurement sensitivity can be enhanced when gas molecules as noise are present other than the target to be detected. The selective reactivity with an organic substance allows the shell to capture a specific molecule, binding site, or structure such as an enzyme in a living body or the receptor of a cell. Particularly, this embodiment is effective for, for example, human exhaled air containing various VOCs in low concentrations.

Structures or methods disclosed in, for example, JP 2002-515980 W, JP 2009-145322 A, JP 2010-066135 A, JP 2010-286466 A, and JP 2015-063535 A may be applied to the biocatalyst (biosensor) according to the present invention.

### Tenth Embodiment

According to a preferred embodiment (tenth embodiment) of the gas detection method of the present invention, the shell is composed of a gasochromic metal.

When the shell is formed to have the structure specified in the tenth embodiment, the shall can have selective reactivity with an inorganic volatile. For example, when tungsten oxide is used as a constituent material of the shell, the shell can have selective reactivity with hydrogen gas. In addition, a brightness change is caused also by a transmittance change due to a gasochromic reaction. Therefore, it is possible to achieve a color change greater than that caused only by a refractive index change and therefore to enhance gas detection accuracy.

Gasochromic properties are properties that optical properties are reversibly changed by the passage of a gas (e.g., hydrogen gas). For example, a gasochromic material whose optical properties are reversibly changed by the passage of hydrogen gas is used, such as a rare-earth metal (e.g., La or Y), an alloy of Mg and another metal, a metal (e.g., Pd, Pt, Ti, V, Zr, Ni, Al, Co, Mn, Cu, Fe, Cr, Ca, In, Sn, Si, or Ge), a transition metal oxide (e.g., WO₃, MoO₃, Nb₂O₅), or a mixture of two or more of them.

Gasochromic tungsten oxide will be described as one example.

In the case of a gas detection system using tungsten oxide (HₓWO₃), when hydrogen gas comes into contact with the surface of a gas detection member, a proton (H⁺) and an electron (e⁻) are generated from a hydrogen atom constituting hydrogen gas in the presence of a catalytic metal, and the proton (H⁺) and the electron (e⁻) are supplied into a tungsten oxide-containing layer constituting a shell due to the spill-over effect of the catalytic metal so that tungsten oxide is changed by proton (H⁺) insertion from a normal hexavalent state to a pentavalent state that is a so-called tungsten bronze structure. Due to intervalence transfer absorption by electrons that transit between the hexavalent state and the pentavalent state, the hydrogen gas detection member is changed into a colored state where visible light in the wavelength range of 600 to 800 nm is absorbed and a specific low light transmittance is achieved. At this time, the tungsten oxide-containing layer, which is colorless and transparent in a normal state, gives a blue color (tungsten bronze).

### Eleventh Embodiment

The gas detection device according to the present invention is a gas detection device comprising a localized surface plasmon sensor that can transmit, reflect, or scatter applied electromagnetic waves and that causes a change in a response spectrum of the applied electromagnetic waves due to interaction with a target to be detected, wherein the localized surface plasmon sensor comprises at least an aggregate of particles having a core-shell structure composed of a core made of a substance having a maximum optical absorption peak wavelength due to surface plasmon resonances in an infrared region and a shell covering the core, the shell absorbs or reacts with the target to be detected to show a change in its refractive index, and the core has an average particle diameter D₁ of 0.6 μm or more but less than the maximum optical absorption peak wavelength of the core.

The same effects as described above with reference to the first to tenth embodiments can be obtained also by the gas detection device according to Items. 11 to 20 of the present invention.

The gas detection method and the gas detection device according to the present invention use a localized surface plasmon sensor that can determine the detection of a target, such as a gas, based on a color change with a high degree of accuracy when the target is detected by localized surface plasmon particles. More specifically, in an environment where a tank, bomb, device or pipe using hydrogen gas or the like is provided, the localized surface plasmon sensor shows a great color change when the leakage of hydrogen gas or the like as a target occurs. Therefore, the leakage of hydrogen gas can be quickly detected by a visual or optical observation means (e.g., camera or spectrophotometer), which makes it possible to take immediate action to ensure the safety of a working environment using hydrogen gas or the like.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A gas detection method using a localized surface plasmon sensor that can transmit, reflect, or scatter applied electromagnetic waves and that causes a change in a response spectrum of the applied electromagnetic waves due to interaction with a target to be detected, wherein
the localized surface plasmon sensor comprises at least an aggregate of particles having a core-shell structure composed of a core made of a substance having a maximum optical absorption peak wavelength due to surface plasmon resonances in an infrared region and a shell covering the core,
the shell absorbs or reacts with the target to be detected to show a change in its refractive index, and
the core has an average particle diameter D₁ of 0.6 μm or more but less than the maximum optical absorption peak wavelength of the core.

2. The gas detection method according to claim 1, wherein the substance constituting the core is an oxide semiconductor.

3. The gas detection method according to claim 1, wherein the substance constituting the core is zinc oxide.

4. The gas detection method according to claim 1, wherein the average particle diameter D₁ (μm) of the cores is in a range of 0.60 to 1.30 μm.

5. The gas detection method according to claim 4, wherein the average particle diameter D₁ (μm) of the cores is in a range of 0.75 to 1.20 μm.

6. The gas detection method according to claim 1, wherein when an average particle diameter of the particles having a core-shell structure is defined as D₂ (μm), a requirement specified by the following formula (1) is satisfied:
1.5×D₁ (μm)<D₂ (μm) Formula (1)

7. The gas detection method according to claim 1, wherein gas detection is performed by
emitting visible light from a light source toward the localized surface plasmon sensor,
detecting spectral information of transmitted, reflected, or scattered light from the localized surface plasmon sensor by a detecting unit, and
calculating a color difference ΔE by a signal processor from the spectral information obtained by the detecting unit.

8. The gas detection method according to claim 1, wherein the localized surface plasmon sensor has a color reference member, which causes no change in absorption wavelength due to gas adsorption, in a region other than a region where the particles having a core-shell structure, which cause a change in response spectrum due to gas adsorption, are present.

9. The gas detection method according to claim 1, wherein the shell is composed of an enzyme comprising a biocatalyst.

10. The gas detection method according to claim 1, wherein the shell is composed of a gasochromic metal.

11. A gas detection device comprising a localized surface plasmon sensor that can transmit, reflect, or scatter applied electromagnetic waves and that causes a change in a response spectrum of the applied electromagnetic waves due to interaction with a target to be detected, wherein
the localized surface plasmon sensor comprises at least an aggregate of particles having a core-shell structure composed of a core made of a substance having a maximum optical absorption peak wavelength due to surface plasmon resonances in an infrared region and a shell covering the core,
the shell absorbs or reacts with the target to be detected to show a change in its refractive index, and
the core has an average particle diameter D₁ of 0.6 μm or more but less than the maximum optical absorption peak wavelength of the core.

12. The gas detection device according to claim 11, wherein the substance constituting the core is an oxide semiconductor.

13. The gas detection device according to claim 11, wherein the substance constituting the core is zinc oxide.

14. The gas detection device according to claim 11, wherein the average particle diameter D₁ (μm) of the cores is in a range of 0.60 to 1.30 μm.

15. The gas detection device according to claim 14, wherein the average particle diameter D₁ (μm) of the cores is in a range of 0.75 to 1.20 μm.

16. The gas detection device according to claim 11, wherein when an average particle diameter of the particles having a core-shell structure is defined as D₂ (μm), a requirement specified by the following formula (1) is satisfied:
1.5×D₁ (μm)<D₂ (μm) Formula (1)

17. The gas detection device according to claim 11, comprising:
a light source unit that emits visible light toward the localized surface plasmon sensor;
a detecting unit that detects spectral information of transmitted, reflected, or scattered light from the localized surface plasmon sensor; and
a signal processor that calculates a color difference ΔE from the spectral information obtained by the detecting unit.

18. The gas detection device according to claim 11, wherein the localized surface plasmon sensor has a color reference member, which causes no change in absorption wavelength due to gas adsorption, in a region other than a region where the particles having a core-shell structure, which cause a change in response spectrum due to gas adsorption, are present.

19. The gas detection device according to claim 11, wherein the shell is composed of an enzyme comprising a biocatalyst.

20. The gas detection device according to claim 11, wherein the shell is composed of a gasochromic metal.
